(19) United States
(12) Patent Application Publication
(10) Pub. No.: US 2026/0225199 A1
(43) Pub. Date: Aug. 6, 2026

(54) SYSTEMS AND METHODS FOR PART ALIGNMENT

(71) Applicant: BLUE ORIGIN MANUFACTURING, LLC, KENT, WA (US)

(72) Inventor: Jonathan Michael Todd Roberts, Gurley, AL (US)

(21) Appl. No.: 19/047,347

(22) Filed: Feb. 6, 2025

(51) Int. Cl. B23Q 3/18

(52) U.S. Cl. CPC B23Q 3/186

(57) ABSTRACT

An alignment system and method for a machined part that includes bottom support having a first mating surface and a top support having a second mating surface configured to engage the first mating surface. Movement of the top support relative to the bottom support may be driven by a support driving system. Movement of the top support may be used to change a rotational and/or an angular orientation of an upper surface of the top support from a first orientation to a second orientation.

### TECHNICAL FIELD

Developments herein relate generally to systems and methods which may include one or more alignment fixtures for aligning one or more axes.

### BACKGROUND

Mounting fixtures may be used to secure a part to surface elements for machining tasks, such as tasks performed by a computer numerical control (CNC) machine. The surface elements may be a base or platform of the machine and the associated parts may be secured to the surface elements so that different machining tools may interact with the part to form a desired end piece. The machining tools may be associated with an alignment system controlled or otherwise evaluated by the machine itself. However, the alignment system may be unaware of the arrangement of the parts, and may therefore, rely on an operator to properly install and secure the part prior to machining. To align the part in a desired orientation with respect to axes of the machine, the operator may use jack screws or shims. Such imprecise alignment is often not compatible with high-precision machining operations with tight tolerances.

### SUMMARY

Developments described herein include a mounting fixture for aligning rotational axes of a part with corresponding axes of a computer numerical control (CNC) machine configured to operate on the part. Embodiments address and overcome problems with conventional methods that use jack screws or shims to adjust the mounting fixture to arrange the part in alignment with the rotational axes of the CNC machine. Systems and methods include a mounting portion having an upwardly-facing spherical or substantially-spherical surface coupled to the CNC machine pallet. A corresponding adjusting portion has a corresponding downwardly-facing spherical or substantially-spherical surface that fits against and/or nests with the upwardly-facing surface of the mounting portion. Accordingly, the adjusting portion can rotate about three orthogonal axes relative to the mounting portion. In certain embodiments, the adjusting portion also has a flat top surface (e.g., a mounting surface) to accommodate mounting fixtures that carry the part to be machined. The mounting portion and the adjusting portion nest together to create a concentric interface. The adjusting portion can be rotated relative to the mounting portion about three rotational axes until the part is aligned with the rotational axes of the CNC machine, and can then be secured in place using one or more fasteners, clips, and/or the like.

A CNC machine pallet can receive and support a mounting portion. The upwardly-facing spherical surface of the mounting portion may be in surface-to surface contact with, so as to be slidably engaged with, the downwardly-facing spherical surface of the adjusting portion. In operation, the adjusting portion is secured to the mounting portion using, as a non-limiting example, one or more fasteners, such as bolts, clamps, adhesives, magnets, friction fittings, and/or the like, once the desired rotational orientation has been achieved. The holes into which the one or more fasteners fit can be oversized to allow angular adjustment. The one or more fasteners may be installed from the “top down” or the “bottom up” to secure the adjusting portion to the mounting portion. Installation from the “bottom up” opposed to the “top down” may provide one or more benefits, such as removing potential interference with the top surface by portions of the one or more fasteners, which may provide more workable area for placing mounting fixtures.

One or more embodiments may include various automated procedures for adjusting the rotational angle of the adjusting portion relative to the mounting portion. For example, a gimbaled two-axis translator may be attached to the center of the adjusting portion by a pin or other coupling device. As the translator stage is moved laterally and longitudinally, the spherical surface of the adjusting portion slidably rotates relative to the spherical surface of the mounting portion to change the orientation of the part, allowing for easier and more fine-tuned control of the orientation angle.

Embodiments of the present disclosure may also replace the adjusting and mounting portions with a set of wedges, which may be referred to as a top wedge and a bottom wedge. The bottom wedge maybe secured to the CNC pallet while the top wedge is positioned on top of the bottom wedge. Rotation of the top wedge, relative to the bottom wedge, may provide different rotational orientation adjustments due to the interface between the wedged or slanted surfaces of the top wedge and the bottom wedge.

Various embodiments may include a mounting and alignment system for a manufactured part that includes a mounting portion and an adjusting portion. The mounting portion may include a concave top surface with a curved sidewall (e.g., a spherical surface) that forms at least a portion of the concave top surface. Additionally, a base may be coupled to and extend from the curved sidewall at a transition. As discussed herein, to secure the adjusting portion, a plurality of apertures may be formed to extend through the curved sidewall. In at least one embodiment, the adjusting portion includes a convex bottom surface with a curved mating surface (e.g., a spherical mating surface) forming at least a portion of the convex bottom surface. A mounting surface (e.g., a top surface) may be formed opposite the bottom surface, which may be used to secure a mounting fixture, such as a rise, that carries or otherwise holds the part to be machined. A plurality of holes may extend through the curved mating surface. An adjustment system may be used to drive movement of the adjusting portion relative to the mounting portion to change an angular orientation of the mounting surface. For example, the curved mating surface may be configured to mate with the curved sidewall and to move along the curved sidewall responsive to a force from the adjustment system.

The mounting and alignment system may also include a fastening system to secure the adjusting portion to the mounting portion, for example via the apertures and holes. In operation, the apertures and holes may be aligned, at least in part, so that a plurality of fasteners (e.g., bolts) and/or a plurality of spherical washers may secure the adjusting portion to the mounting portion and/or may be used to secure a fastening surface formed on the adjustment plate. In certain embodiments, the plurality of spherical washers are used to engage the fastening surface on an opposite side from the curved sidewall. To permit additional adjustment and/or movement, respective aperture diameters of the plurality of apertures may be less than respective hole diameters of the plurality of holes. As a result, the adjustment plate may be used to pivot along the additional diameters provided by the plurality of holes. Various types of fasteners or fastening systems may be used to secure the adjusting portion to the mounting portion, such as clamps, magnetic fittings, friction fittings, adhesives, and/or combinations thereof. Furthermore, the fasteners may be manually or automatically engaged. As one example, fasteners such as bolt and washer arrangements, may be used to secure the adjusting portion to the mounting portion. As another example, an automated system, such as pneumatic, electric, or hydraulic fasteners may be used to secure the adjusting portion the mounting portion. In operation, the adjustment system may be used to apply a force to the adjustment plate, which may include a plurality of force members extending through a skirt formed along an outer diameter of the adjustment portion. At least one force member of the plurality of force member may be configured to engage the mounting portion to change the angular orientation of the mounting surface from a first orientation to a second orientation. The adjustment system may include a pin extending laterally from the base on a side of the base opposite the transition and a two-axis translator coupled to the pin. Movement of the pin along a first axis or a second axis of the two-axis translator may be configured to change the angular orientation of the mounting surface from a first orientation to a second orientation. Additionally, or in the alternative, the adjustment system may also include a first application element and a pivot coupled to the base. A lateral force may be applied to the base by the first application element to change the angular orientation of the mounting surface from a first orientation to a second orientation.

Various embodiments may be directed toward an alignment system. The alignment system may include a bottom support, a top support, and a support driving system. The bottom support may have a first mating surface that is engaged by a second mating surface of the top support. The support driving system may be used to move the top support relative to the bottom support to change an angular orientation of an upper surface of the top support from a first orientation to a second orientation. In one or more embodiments, the first mating surface has a first slope, the second mating surface has a second slope, and the support driving system is configured to drive rotational movement of the top support about a longitudinal axis extending through the bottom support and the top support. The alignment system may also include a mounting plate coupled to the top support. Operation of the support driving system may be used to adjust a second angular orientation of the mounting plate with respect to the top support. As discussed herein, the first mating surface may be a curved concave surface, the second mating surface may be a curved convex surface, and the support driving system may be configured to drive longitudinal movement of the top support between a first position and a second position. The first mating surface may be secured to the second mating surface using one or more mechanical fasteners extending through a first hole of the first mating surface and a second hole of the second mating surface. Additionally, a first diameter of the first hole may be less than a second diameter of the second hole. As a result, movement of the top support may be permitted, even when there is partial alignment between the first and second holes. In at least one embodiment, the support driving system is used to apply at least one of an axial force, a rotational force, or a lateral force to the top support. The alignment system may also include one or more travel indicators positioned at an interface between the first mating surface and the second mating surface.

One or more embodiments may be directed toward a method to adjust a surface orientation. The method may include determining a current surface orientation is different from a desired surface orientation and then determining an adjustment to be performed to an adjusting portion, relative to a mating portion, to transition from the current surface orientation to the desired surface orientation. The adjustment may include determining a different angle or rotational position for the surface. The adjustment may then be applied to the adjusting portion and it may be determined that an adjusted surface orientation is within a threshold amount of the desired surface orientation. Thereafter, the adjusting portion may be secured to the mating portion. The adjustment may include at least one of a lateral force, an axial force, or a rotational force. In embodiments, platform may be secured to the adjusting portion and a working part may be secured to the platform. For example, the adjustment may be based on an orientation of the working part. Additionally, the adjustment may cause movement of a curved surface of the adjusting portion along a mating curved surface of the mating portion.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1 illustrates an example machining system with an alignment system, according to at least one embodiment;

FIG. 2A illustrates an example of an alignment system, according to at least one embodiment;

FIG. 2B illustrates an example of an alignment system, according to at least one embodiment;

FIG. 3 illustrates an isometric view of an alignment system including a mounting fixture and part, according to at least one embodiment;

FIG. 4 illustrates a top isometric view of an example of a mounting portion of an alignment system, according to at least one embodiment;

FIG. 5 illustrates a bottom isometric view of an example of an adjusting portion of an alignment system, according to at least one embodiment;

FIG. 6 illustrates a cross-sectional side view of an alignment system, according to at least one embodiment;

FIGS. 7A-7D illustrate a sequence of alignment configurations for an alignment system, according to at least one embodiment;

FIG. 8A illustrates a schematic diagram of an example of an adjustment system for an alignment system, according to at least one embodiment;

FIG. 8B illustrates a schematic diagram of an example of an adjustment system for an alignment system, according to at least one embodiment;

FIGS. 9A and 9B illustrate a schematic diagram of an example of an adjustment system in a first position and a second position, according to at least one embodiment;

FIG. 10 illustrates a schematic diagram of an example of a control environment, according to at least one embodiment;

FIG. 11A illustrates an example process for aligning a surface, according to at least one embodiment;

FIG. 11B illustrates an example process for aligning a surface, according to at least one embodiment;

FIG. 12 illustrates computing features of an environment for a control system for a containment system, according to at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Systems and methods are directed, at least in part, to a mounting fixture for aligning rotational axes between a part and a machine performing one or more operations on the part. At least one embodiment includes a mounting portion with a spherical surface that receives an adjusting portion. In operation, the adjusting portion has a bottom surface that mates with the spherical surface to permit movement and adjustment of an angular orientation of a mounting surface of the adjusting portion. Various methods may be deployed to move the adjusting portion, such as circumferential screws to make adjustments, linear actuators, a ball-mounted pivot, and/or the like. The adjusting portion includes apertures that align with receptacles formed in the mounting portion. Washers may be used to secure the adjusting portion to the mounting portion when the adjusting portion is arranged at a desired position, which may be measured by one or more sensors and/or controlled electronically using a control system. A part being worked on by the machine may then be mounted to a mounting fixture positioned on the mounting surface of the adjusting portion, to the mounting surface of the adjusting portion, and/or combinations thereof.

As used herein, a mounting portion may refer to a structure that is secured to a pallet or base of a machine, which may include a CNC machine in one or more embodiments. The mounting portion may be formed from one or more materials, such as metals or metal alloys, that may be selected based on durability, corrosion resistance, or combinations thereof. One non-limiting material is A36 steel with electroless nickel plating, but embodiments may use a variety of different materials, such as nickel alloys, and/or materials with low surface roughness to reduce or even eliminate use of lubricants. Furthermore, one or more dry lubricants may be applied to surfaces of the system to reduce friction.

As used herein, an adjusting portion may refer to a structure that is arranged axially above, at least in part, of the mounting portion and that is moveable with respect to the mounting portion. Moveable may refer to rotational movement, lateral movement, axial movement, or combinations thereof. In at least one embodiment, the adjusting portion may be in contact with the mounting portion such that movement may include sliding or otherwise rotating along an interface between the adjusting portion and the mounting portion. The adjusting portion may further be formed from one or more materials, such as metals, that may also be selected for durability, corrosion resistance, or combinations thereof. The selection of the material for the adjusting portion may be based on the selection for the mounting portion. For example, the adjusting portion may be formed from a material that is softer than the mounting portion to prevent marring or scarring of the mounting portion. Similarly, the adjusting portion may be formed from a dissimilar material, for example to prevent galvanic corrosion, or from a similar material. Additionally, one or more coatings may be applied to the adjusting portion to facilitate movement along the mounting portion. One non-limiting material is A36 steel with electroless nickel plating, but embodiments may use a variety of different materials, such as nickel alloys, and/or materials with low surface roughness to reduce or even eliminate use of lubricants.

As used herein, machining or working on a part may refer to a machining process that may include one or more axes, such as axes of rotation for one or more work pieces. A machine may be a multi-axis machine and may include a variety of different axes, which may further be movable. For example, a CNC machine may include a horizontal axis (e.g., an x-axis), a vertical axis (e.g., a y-axis), and/or the like. The single machine may be used for a variety of operations, including milling or drilling operations, and as a result, may pivot between different working tools or adjust axes for working tools. Working tools may include, as non-limiting examples, turning tools, milling tools, drilling tools, and grinding tools. One or more axes for the machine may be known or otherwise determinable by the machine using one or more sensors, for example using an on-board control system.

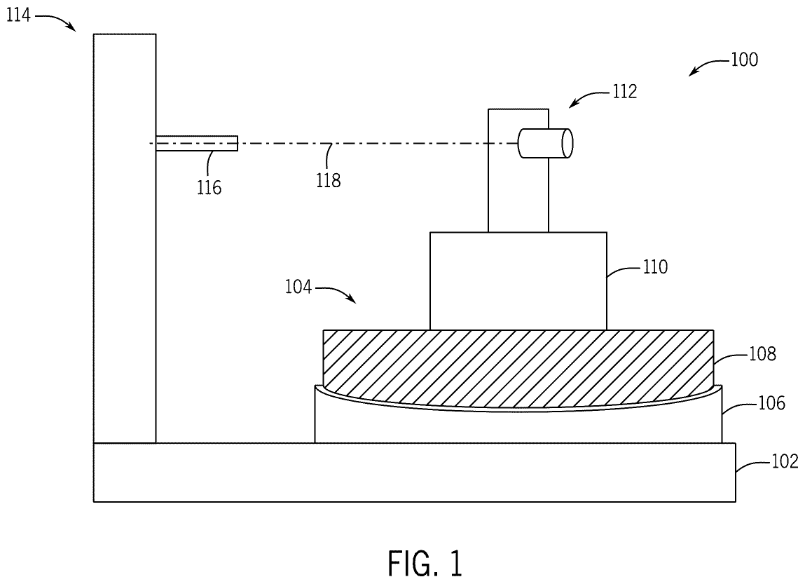

FIG. 1 illustrates a schematic representation of an embodiment of a machining system 100 that may be used with various embodiments of the present disclosure. The machining system 100 may be used with a variety of different machining applications, which may include using machines such as drilling machines, grinding machines, milling machines, lathes, broaching machines, laser cutting machines, presses, plasma cutting machines, and/or the like. For clarity and simplicity, the machines may be referred to as CNC machines, which are programmable machines that may use numerical control methods to move one or more working tools. The illustrated example includes a pallet 102 (e.g., machine pallet) that may form a portion of the machine, such as a base. As discussed herein, one or more sensors associated with the machine may be used to position the working tools with respect to the pallet 102.

Embodiments of the present disclosure may include an alignment system 104 that includes a mounting portion 106 and an adjusting portion 108. In operation, the adjusting portion 108 may be movable with respect to the mounting portion 106, which may adjust or change a position of a plate or surface associated with the adjusting portion 108. A mounting fixture 110 is shown coupled to the adjusting portion 108 to receive and support a part 112 to be machined.

In at least one embodiment, the alignment system 104 may be used to align one or more axes of the part 112 with corresponding axes of a machine 114 that performs one or more operations to the part 112. For example, the machine 114 may include one or more working tools 116 with one or more respective axes 118. Alignment of the part 112 with the axis 118 may enable precision machining operations. However, if the part 112 is misaligned, subsequent machining operations may also be misaligned, leading to parts that are either improperly machined or out of tolerance. Embodiments of the present disclosure may use the alignment system 104 to drive rotation and/or movement of the adjusting portion 108 about three orthogonal axes relative to the mounting portion 106. Rotation and/or movement of the adjusting portion 108 may be used to pivot or otherwise modify a position of the part 112 until the part 112, and/or one or more target regions of the part 112, is aligned with the axis 118 of the working tool 116.

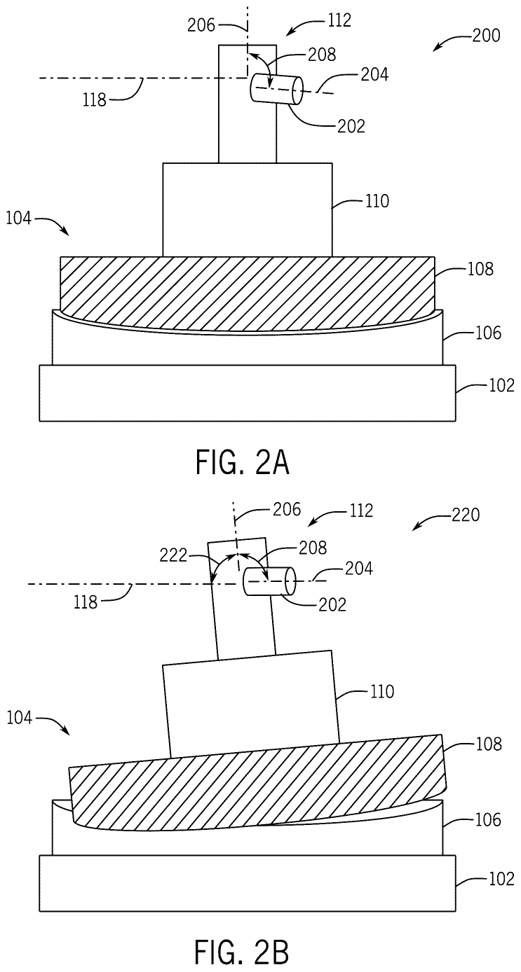

FIG. 2A illustrates an example mounting scenario 200 that may be used with embodiments of the present disclosure. In this configuration, the mounting fixture 110 is positioned on the adjusting portion 108, which is arranged on the mounting portion 106. The part 112 is mounted to the mounting fixture 110 and includes a component 202 with an axis 204 that is offset from a part axis 206 by an angle 208. In other words, the axis 204 is not arranged perpendicular to the part axis 206, and as a result, may not be aligned with the axis 118 of the working tool 116 (FIG. 1). Embodiments of the present disclosure may be used to adjust the position of the part 112 so that the axis 204 is aligned with the axis 118.

FIG. 2B illustrates an example mounting scenario 220 that may be used with embodiments of the present disclosure to adjust a position of the part 112. In this configuration, the alignment system 104 is used to pivot the part 112 so that the axis 118 is aligned with the axis 204. For example, in one or more embodiments, the mounting portion 106 may include a curved surface and the adjusting portion 108 may include a mating curved surface that permits movement of the adjusting portion 108 with respect to the mounting portion 106. Movement may include movement with respect to three orthogonal axes and, in this example, may adjust or pivot the part 112 to effectively rotate the part 112. As a result, an angle 222 between the part axis 206 and the working tool 116 is reduced, compared to the 90-degree angle formed in FIG. 2A, while the angle 208 is maintained. In this manner, the axis 204 is now co-axial with the axis 118, enabling operation on the component 202 by the working tool 116. Embodiments may permit fine tuning and movement of different components to align different regions of the part 112 with the various axes 118 of the machine.

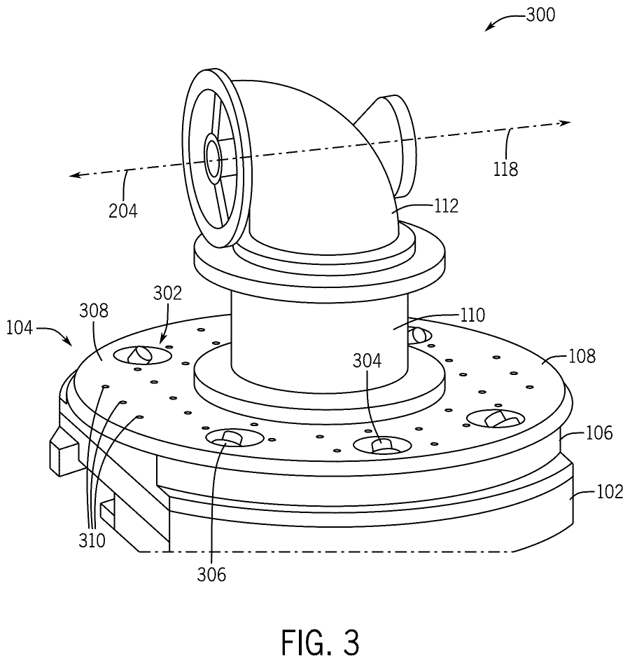

FIG. 3 is an isometric view of an embodiment of a machining system 300 that may be used with embodiments of the present disclosure. In this example, each of the pallet 102, alignment system 104, mounting fixture 110, and part 112 are shown coupled together to align the axis 204 with the axis 118. The adjusting portion 108 is coupled to the mounting portion 106 via one or more fasteners 302, which in this example includes bolts 304 and may also include washers 306. The washers 306 may be spherical washers. It should be appreciated that the illustrated configuration shows the bolts 304 and washers 306 extending from the “top down” into the mounting portion 106, but other embodiments may include connections from the “bottom up.” Additional, or alternative, fasteners 302 may be used to secure the adjusting portion 108 to the mounting portion 106. For example, one or more automated systems, such as systems driven by pneumatic, electric, and/or hydraulic actuators, may be used in place or, or with, the bolts 304 and/or the washers 306. The fasteners 302 may be associated with one or more automated systems that may be used to adjust a position of the adjusting portion 108 relative to the mounting portion 106 and then engage one or more fasteners 302 to secure the adjusting portion 108 into a desired position.

In at least one embodiment, the adjusting portion 108 includes a mounting surface 308 (e.g., a top surface) with a plurality of holes 310 to facilitate mounting of different structures, fixtures, and/or the like on the mounting surface 308, such as the mounting fixture 110. In this example, the holes 310 are spaced out in a series of rows and columns to enable a variety of different potential mounting configurations. While a single mounting fixture 110 is illustrated in FIG. 3, other configurations may include multiple different mounting fixtures 110.

As will be discussed herein, the adjusting portion 108 may include a mating curved surface that interfaces with a curved surface of the mounting portion 106 to permit multi-axis movement of the adjusting portion 108, and therefore, multi-axis movement of the mounting surface 308, to change an orientation of the axis 204. In this manner, the adjusting portion 108 can be moved relative to the mounting portion 106 to align the axis 204 with the axis 118.

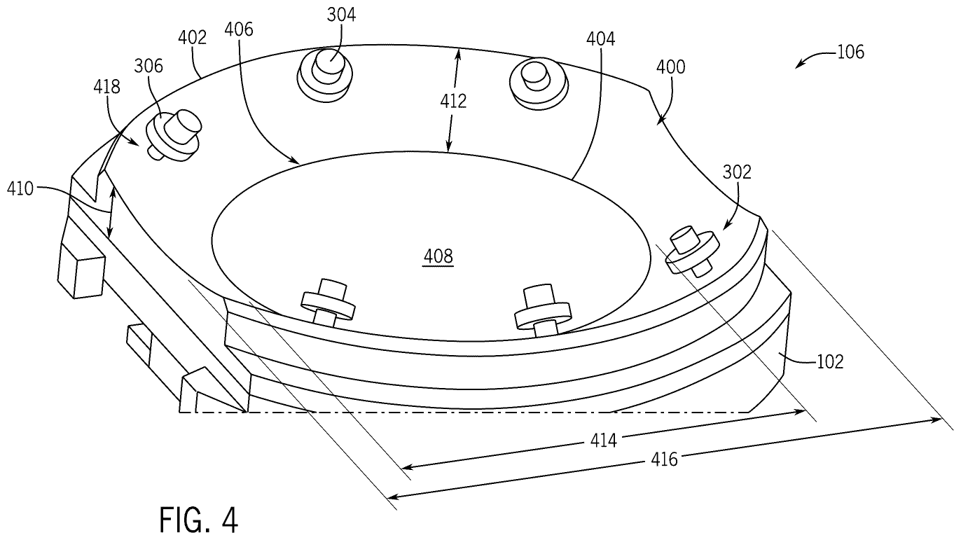

FIG. 4 illustrates a top perspective view of an embodiment of the mounting portion 106 coupled to the pallet 102. The adjusting portion 108, as shown in FIGS. 1-3, has been removed to illustrate features of the mounting portion 106, however, the fasteners 302 are illustrated, including the bolts 304 and the washers 306. In this example, the mounting portion 106 includes a curved surface 400, which may be a substantially spherical or semi spherical, conical, or trapezoidal shape. That is, the curved surface 400 may form a sidewall associated with the mounting portion 106 and the curved surface 400 may be spherical or semi spherical or otherwise concave or trapezoidal. The curved surface 400 is shown to extend annularly around a perimeter of the mounting portion 106 from a top curved region 402 to a bottom curved region 404. At the bottom curved region 404, a transition 406 is illustrated toward a bottom 408 of the mounting portion. In this example, the bottom 408 is substantially flat or planar, but in other embodiments the bottom 408 may also be curved. Further, the bottom 408 may include one or more openings that permit force transition members to extend through the bottom 408 to act on the adjusting portion 108 when the adjusting portion 108 is positioned in contact with the mounting portion 106. Additionally, the bottom 408 may also be a base for one or more force translation members. One or more dimensions may be particularly selected based on a desired adjustment level for the system. For example, a depth 410 of the mounting portion 106, a length 412 of the curved sides, a diameter 414 of the bottom, a diameter 416 of the top curved region 402, an angle of the curved sides, or a variety of other dimensions may be particularly selected based on desired operational parameters.

The mounting portion 106 includes a plurality of openings 418 (e.g., apertures, holes, etc.) that receive the bolts 304. The example illustrates six openings 418, but there may be more or fewer depending on desired operating conditions. Additionally, the arrangement of the openings 418 on either side of the mounting portion 106 is also for illustrative purposes and the openings 418 may be arranged circumferentially and evenly spaced around and along the curved surface 400.

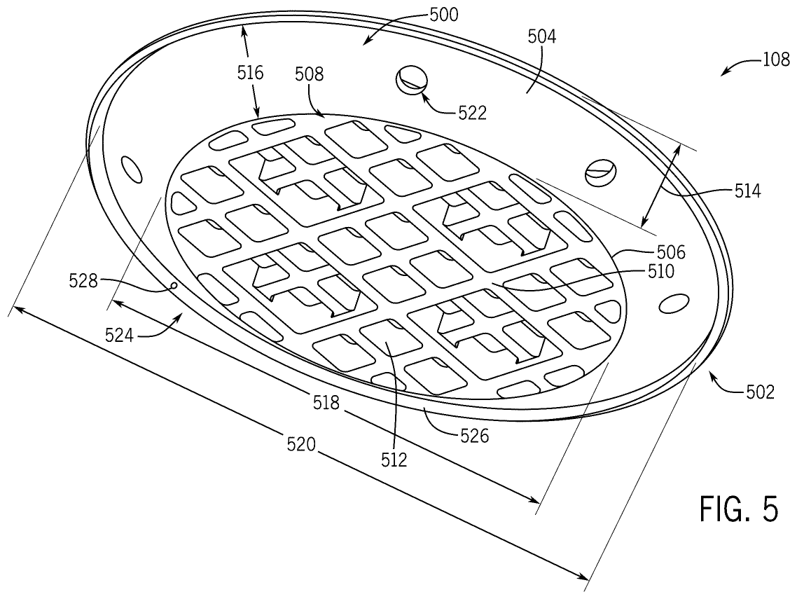

FIG. 5 illustrates a perspective view of an embodiment of the bottom portion or section of the adjusting portion 108 that may be used with embodiments of the present disclosure. A curved mating surface 500 is illustrated along a perimeter of the adjusting portion 108 along the bottom side 502, which is opposite the mounting surface 308 shown in FIG. 3. Similar to the configuration shown with respect to the mounting portion 106 as shown in FIG. 4, the curved mating surface 500 is shown extending annularly around a perimeter of the adjusting portion 108 from a top region 504 to a bottom region 506. Accordingly, embodiments may describe the curved mating surface 500 as forming, at least in part, sidewalls of an at least partially spherical bottom of the adjusting portion 108. At the bottom region 506, a transition 508 is illustrated between the curved mating surface 500 and a bottom 510. The bottom 510 may be substantially flat or planar, and various embodiments may also include openings 512, which may be used to reduce weight and material use for the adjusting portion 108.

The illustrated adjusting portion 108 may have one or more dimensions particularly selected based on the configuration used for the mounting portion 106. For example, a depth 514 may be selected based on the depth 410 of the mounting portion 106. Additionally, various other dimensions such as a length 516 of the curved mating surface sides, a diameter 518 of the bottom, a diameter 520 of the top region 504, an angle of the curved sides, or a variety of other dimensions.

To couple the adjusting portion 108 to the mounting portion 106, holes 522 (e.g., openings, apertures, etc.) extend through the curved mating surface 500. When the adjusting portion 108 is positioned on the mounting portion 106, for example such that the curved mating surface 500 engages the curved surface 400, the holes 522 may be aligned with the openings 418 to secure the adjusting portion 108 to the mounting portion 106. In at least one embodiment, additional fine-tuning structure may be incorporated into one or both of the mounting portion 106 or the adjusting portion 108, as discussed herein. The illustrated holes 522 are shown in an arrangement such that the center line of each hole 522 is at an equal radial position with respect to a vertical axis (e.g., an axis extending through the bottom 510 toward the top region 504). That is, the holes are arranged at a common axial height along the length 516 with respect to one another. However, other embodiments may include different configurations for the holes 522, with some holes being closer to the bottom 510 than others.

The illustrated adjusting portion 108 also includes a lip 524 extending radially from the top region 504. The lip 524 includes a downwardly sloped portion 526 with a plurality of openings 528 extending through the lip 524. As discussed herein, one or more fasteners may extend through the openings 528 to secure and/or tune a position of the adjusting portion 108 with respect to the mounting portion 106. For example, force application members may extend through the openings 528 to drive movement of the adjusting portion 108.

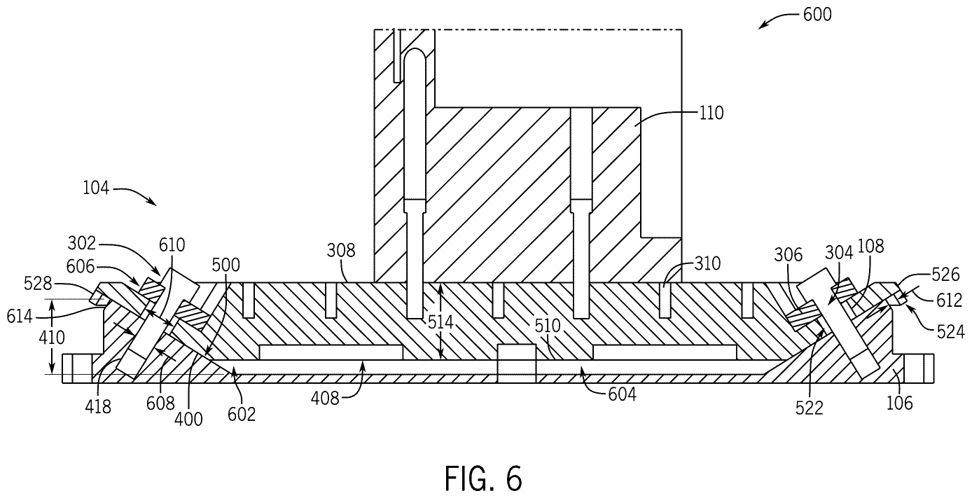

FIG. 6 illustrates a cross-sectional side view of an embodiment of a mounting configuration 600 that includes the alignment system 104 with the mounting fixture 110. As discussed herein, certain elements are removed for clarity, such as the pallet 102. Furthermore, various features may be shared with embodiments shown in FIGS. 1-5. The adjusting portion 108 is shown within a cavity 602 of the mounting portion 106 formed by the curved or slanted surface 400 extending downwardly toward the bottom 408. The curved mating surface 500 is positioned in contact with the curved surface 400 and, responsive to one or more forces, may move or slide along the curved surface 400 along at least three axes.

In this example, the depth 410 associated with the mounting portion 106 is greater than the depth 514 of the adjusting portion 108, which forms a gap 604 between the bottom 408 of the mounting portion 106 and the bottom 510 of the adjusting portion 108. The gap 604 may be closed or reduced as the adjusting portion 108 moves along the curved surface 400. The size of the gap 604 is shown by way of non-limiting example and may be larger or smaller depending on selected dimensions for one or both of the mounting portion 106 and/or the adjusting portion 108. In embodiments, the gap 604 may house one or more force application members and/or may permit application of the forces through the mounting portion 106.

The adjusting portion 108 is secured to the mounting portion 106 using the fasteners 302, which include the bolts 304 and the washers 306. As discussed, the use of the bolts 304 and washers 306 is provide by way of non-limiting example and other systems may be used, such as magnetic fittings, clamps, adhesives, and/or the like. Furthermore, the configuration shown in FIG. 6 illustrates the “top down” arrangement with the washer 306 against the adjusting portion 108. However, in one or more embodiments, the “bottom up” arrangement may be used where the washer 306 engages the mounting portion 106. The bolts 304 extend through the openings 418 and the holes 522 and are further secured by the washers 306. In one or more embodiments, the bottom of a counterbore 606 that includes the holes 522 is co-spherical to the surface 400, 500 and/or with respect to the washers 306, which may be spherical washers. In the illustrated example, a first diameter 608 for the openings 418 is less than a second diameter 610 for the hole 522, thereby providing gaps for movement of the adjusting portion 108 along the curved surface 400. For example, the difference in diameters 608, 610 may provide a movement limit or otherwise control an amount of movement along the curved surface 400. That is, the movement of the adjusting portion 108 may be restricted by contact between the bolts 304 and the sidewalls of the hole 522. Accordingly, larger holes 522 may provide more range of movement.

Additionally, one or more embodiments may also use the lip 524 to restrict or otherwise control movement of the adjusting portion 108. As a result, a lip extension distance 612 may further be used to determine a range of movement for the adjusting portion 108. For example, if the adjusting portion 108 moves too far along the curved surface 400, the lip 524 may contact or otherwise engage a stop shoulder 614 of the mounting portion 106, thereby blocking further movement of the adjusting portion 108. In certain embodiments, the stop shoulder 614 has a common angle as the downwardly sloped portion 526. Accordingly, movement may be controlled by a variety of different features of the adjusting portion 108 to tune or otherwise limit movement.

The openings 528 in the lip 524 may be used for fine tuning and/or to secure the adjusting portion 108 into position. For example, one or more force application members and/or fasteners may extend through openings 528 and engage the mounting portion 106, for example along the stop shoulder 614, to cause movement and/or block further movement of the adjusting portion 108. In embodiments, the one or more fasteners may also be used to fine-tune movement of the adjusting portion 108, such as by applying small amounts of force to adjust or otherwise drive movement of the adjusting portion 108.

The mounting fixture 110 may then be secured to the mounting surface 308 of the adjusting portion 108 using the holes 310. For example, one or more fasteners may be used to secure the mounting fixture 110 to the pattern of the holes 310 in the mounting surface 308. In this manner, the mounting fixture 110 and/or the part thereon, may be positioned in alignment with one or more axes of the associated machine performing operations on the part.

Various embodiments of the present disclosure may provide a variety of configurations to secure the adjusting portion 108 to the mounting portion 106. For example, the illustrated fasteners 302 as positioned in a “top down” arrangement where the bolt 304 is inserted through the adjusting portion 108 into the mounting portion 106. In one or more embodiments, the bolts 304 may be installed in a “bottom up” configuration where the bolt 304 is inserted through the mounting portion 106 from the bottom side and then into an orifice in the adjusting portion 108. Such a configuration may provide a larger mounting surface 308 for mounting a variety of different mounting fixtures 110. Additionally, one or more embodiments may also include different hole arrangements to provide additional degrees of freedom of movement. For example, certain holes 522 may be radially closer (e.g., closer to the bottom 510 along the length 516) than other holes 522, which may be used to provide more or less movement of the adjusting portion 108.

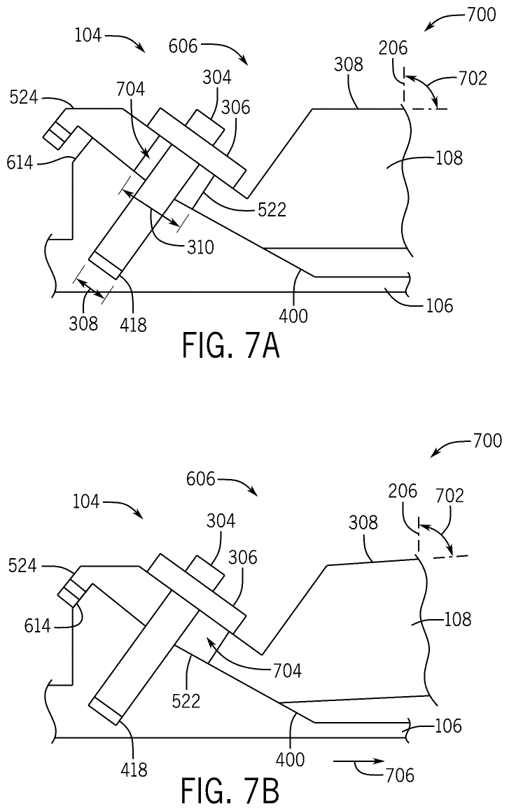

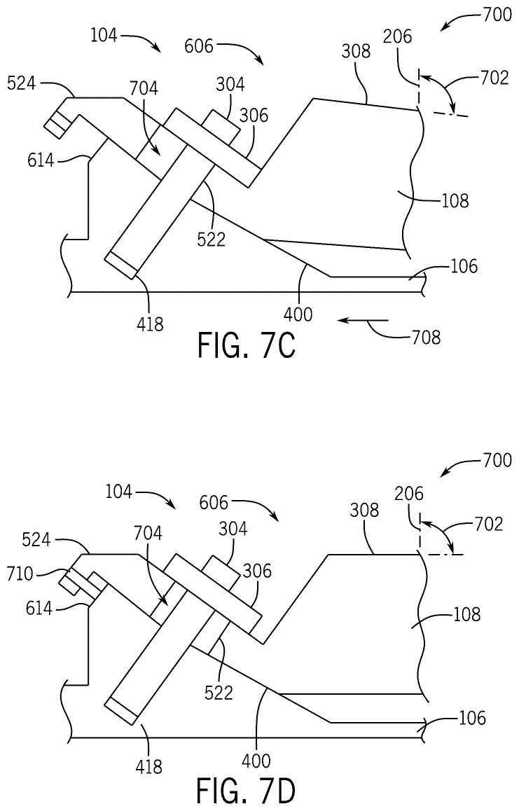

FIGS. 7A-7D illustrate partial schematic cross-sectional views of a series of adjustments 700 that may be used with embodiments of the present disclosure to change an angle 702 of the mounting surface 308 with respect to the part axis 206, which may be used to position the part in line with an axis of an associated machine. The illustrated example of FIG. 7A includes the adjusting portion 108 coupled to the mounting portion 106 via the fasteners 302, which include the bolt 304 and the washer 306. The bolt 304 extends through the counterbore 606 and the hole 522 and into the opening 418 and is secured in place by the washers 306. As shown in the illustrated arrangement, the hole 522 extends entirely through the adjusting portion 108 while the opening 418 only extends a determined distance into the mounting portion 106. However, it should be appreciated that in alternative configurations, such as the “bottom up” configuration, the opening 418 may extend through the mounting portion 106 and the hole 522 may not extend fully through the adjusting portion 108. In this example, the lip 524 is positioned away from the stop shoulder 614, thereby enabling further adjustment or movement of the adjusting portion 108 relative to the mounting portion 106. Additionally, because of the difference between the first diameter 608 and the second diameter 610, there is additional travel distance 704 for the adjusting portion 108. The travel distance 704 may be equal to the difference between the first diameter 608 and the second diameter 610, which may be distributed on either side of the bolt 304.

FIG. 7B illustrates the adjustment 700 after the adjusting portion 108 is moved such that the lip 524 contacts the stop shoulder 614, preventing further movement of the adjusting portion 108 (e.g., blocking movement in the lateral direction, represented by an arrow 706). In this example the adjusting portion 108 may contact or engage the bolt 304 because the travel distance 704, which was previously split on either side of the bolt 304, is now translated to the opposite side of the bolt 304. Because of the movement, the mounting surface 308, due to sliding along the curved surface 400, may be tilted upward, thereby decreasing the angle 702 compared to the angle 702 in FIG. 7A.

FIG. 7C illustrates the adjustment 700 after the adjusting portion 108 is moved such that the lip 524 moves away from the stop shoulder 614, compared to FIG. 7B, but such that the adjusting portion 108 contacts the bolt 304 preventing further movement of the adjusting portion 108 (e.g., blocking movement in the lateral direction, represented by an arrow 708). In this example, the travel distance 704, which was previously on the opposite side of the bolt 304, is now translated to the side proximate the lip 524. Because of the movement, the mounting surface 308, due to sliding along the curved surface 400, may be tilted downward, thereby increasing the angle 702 compared to the angles 702 in FIGS. 7A and 7B.

FIG. 7D illustrates the adjustment 700 in which a tuning pin 710 extends through the opening 528 in the lip 524 to engage the stop shoulder 614. The tuning pin 710 may be used to secure the adjustment portion 108 in place and/or to provide fine adjustments to the position of the adjustment portion 108 along the curved surface 400. For example, the tuning pin 710 may apply a force against the mounting portion 106, which may drive the adjusting portion 108 to move relative to the mounting portion 106.

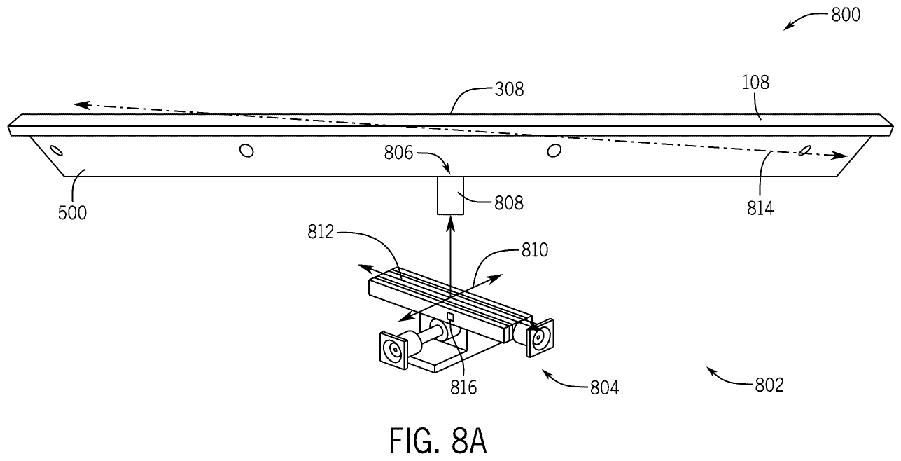

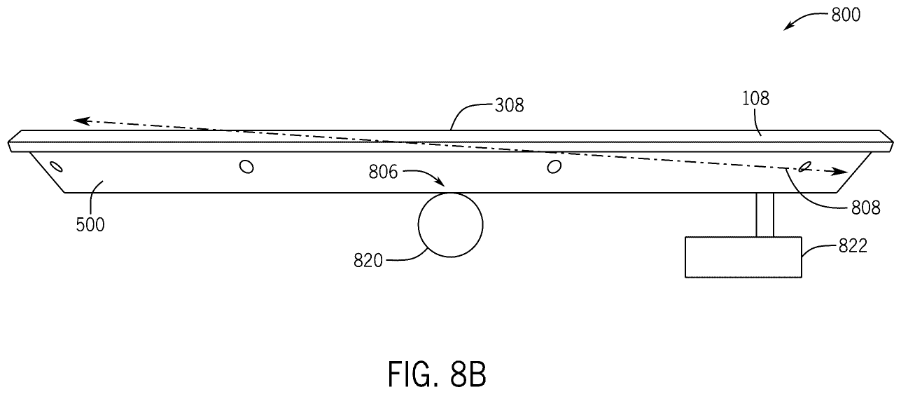

FIGS. 8A and 8B illustrate example schematic configurations 800 for one or more adjustment systems 802 that may be used with embodiments of the present disclosure. In at least one embodiment, the one or more adjustment systems 802 may be used to modify a rotational angle of the adjusting portion 108 relative to the mounting portion 106 using one or more actuated drives, such as the illustrated translator 804 in FIG. 8A. The translator 804 includes, as one non-limiting example, a gimbaled two-axis translator that is attached to a center 806 of the adjusting portion 108 by a pin 808. As the translator stage is moved laterally (e.g., along the axis 810) and longitudinally (e.g., along the axis 812), the curved mating surface 500 of the adjusting portion 108 slidably rotates relative to the curved surface 400 of the mounting portion 106 to change the orientation of the mounting surface 308, and therefore the part, as illustrated by the dashed line 814. Accordingly, systems and methods may deploy one or more automated control arrangements for part adjustment, which may include, in part, one or more dials or position indicators 816 to record and provide improved fine-tuned control of the orientation of the mounting surface 308.

FIG. 8B illustrates the configuration 800 in which the adjustment system 802 includes a ball pivot 820 and an actuated drive 822. In operation, the ball pivot 820 may be positioned at the center 806 and, responsive to an upward force applied by the actuated drive 822, the mounting surface 308 may pivot as the curved mating surface 500 moves along the curved surface 400 of the mounting portion 106.

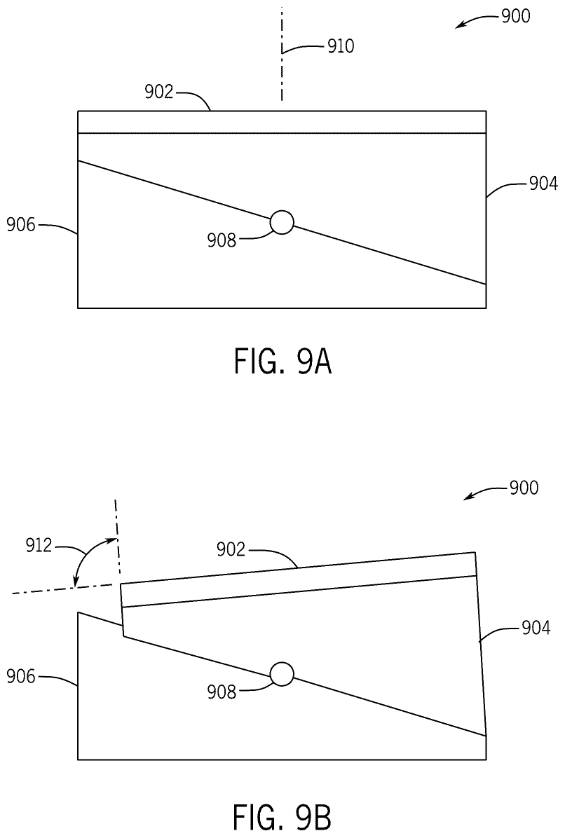

FIGS. 9A and 9B illustrate schematic views of an embodiment of an alignment system 900 that includes a top plate 902, a first wedge 904, and a second wedge 906. In operation, rotation of the first wedge 904 relative to the second wedge 906 may cause one or more changes in an orientation of the top plate 902. In at least one embodiment, an indicator 908 is included, such as a dial indicator, to provide feedback to an operator regarding an amount of rotation of the first wedge 904 relative to the second wedge 906. As the first wedge 904 is rotated about an axis 910, the top plate 902 follows along the angled slope of the second wedge 906, thereby forming an angle 912 relative to an orientation of a ground plane. Accordingly, a part arranged along the top plate 902 may also be positioned at the orientation with respect to the angle 912.

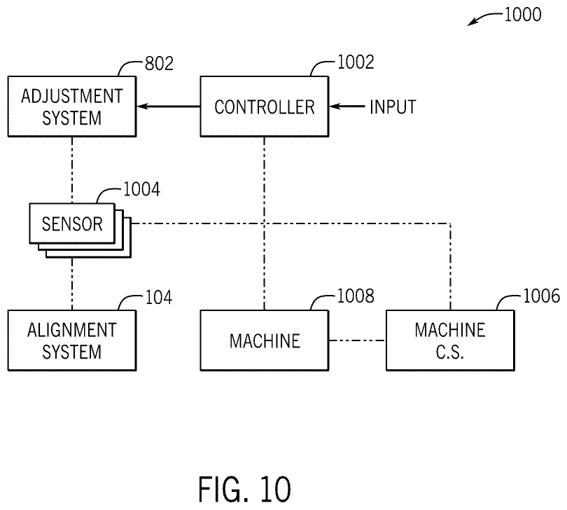

FIG. 10 illustrates an example control environment 1000 that may be used with embodiments of the present disclosure. In this example, a controller 1002 may be used to transmit one or more control signals to the adjustment system 802. For example, the controller 1002 may provide signals to apply a force to move the translator 804 to adjust a position of the adjusting portion 108. One or more sensors 1004, which may include the indicators 816, 908, and/or additional or alternative sensors, may provide information to the controller 1002, which may be used to determine and adjust the control signal transmitted to the adjustment system 802. For example, upon determining a position of the adjustment system 802, the adjustment system position may be correlated to an associated position of the alignment system 104, such as a location of the adjusting portion 108 relative to the mounting portion 106. Information from the one or more sensors 1004 may be used to cause the adjustment system 802 to drive the alignment system 104. Once in position, the controller 1002 may further be used to initiate or drive one or more automated fastening systems to secure the adjusting portion 108 to the mounting portion 106, for example one or more pneumatic, electric, and/or hydraulic fastening systems, such as a pneumatic bolt or clamp, as non-limiting examples.

In at least one embodiment, the controller 1002 may be integrated with, or be connected to, a control system 1006 associated with one or more machine 1008, such as CNC machines as one non-limiting example. Information from the machine 1008 and/or the control system 1006 may further be used to adjust or otherwise provide instructions to the adjustment system 802. Furthermore, in certain embodiments, the controller 1002 may receive input from one or more operators, such as a command to adjust the alignment system 104 to a predetermined or stored position, among other options.

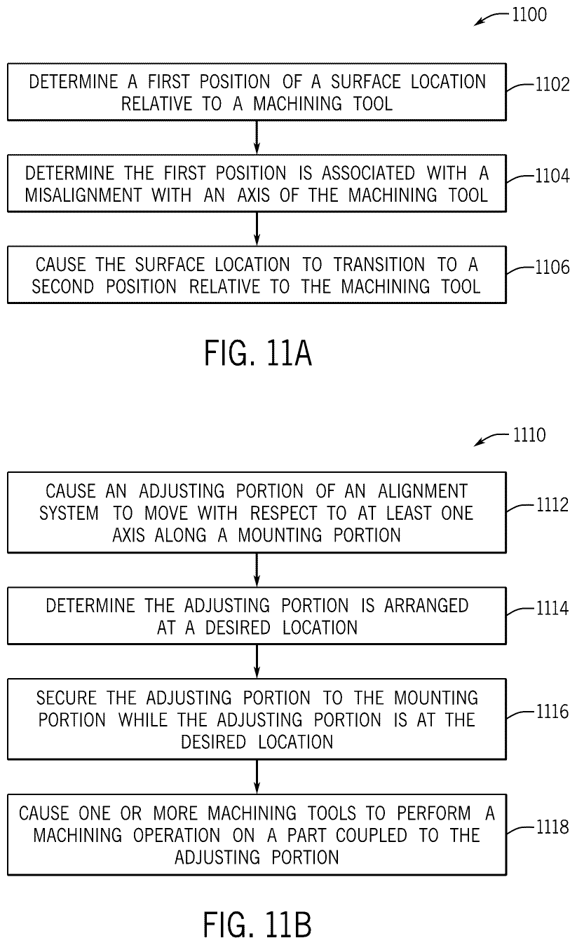

FIG. 11A illustrates an example process 1100 to adjust a surface location, in accordance with various embodiments. It should be understood that for this and other processes presented herein that there may be additional, fewer, or alternative operations performed in similar or alternative orders, or at least partially in parallel, within the scope of the various embodiments unless otherwise specifically stated. In this example, a first position of a surface location is determined relative to a machining tool 1102. In at least one embodiment, the first position of the surface location may be correlated to or associated with an axis or portion of a part coupled to the surface location. It may be determined that the first position is associated with a misalignment with an axis of the machining tool 1104. The misalignment may include a position or location of the surface, or an associated part on the surface, that is not oriented or otherwise aligned with one or more working axes of the machining tool. As a result, the surface location may be transitioned to a second position relative to the machining tool 1106. For example, the surface location may be driven to a different angle by one or more alignment systems.

FIG. 11B illustrates an example process 1110 to adjust a surface location, in accordance with various embodiments. In this example, an adjusting portion of an alignment system may be driven to move with respect to at least one axis along a mounting portion 1112. The alignment system and may include the adjusting portion and the mounting portion in contact along curved or spherical edges. As a result, movement of the alignment system may be enabled along three axes. After causing movement of the adjusting portion, it may be determined that the adjusting portion is arranged at a desired location 1114. For example, the adjusting portion may be oriented to align with one or more axes of a machine, such as a CNC machine. The adjusting portion may then be secured to the mounting portion at the desired location 1116. Thereafter, one or more machining tools may perform one or more machining operations on a part coupled to the adjusting portion 1118.

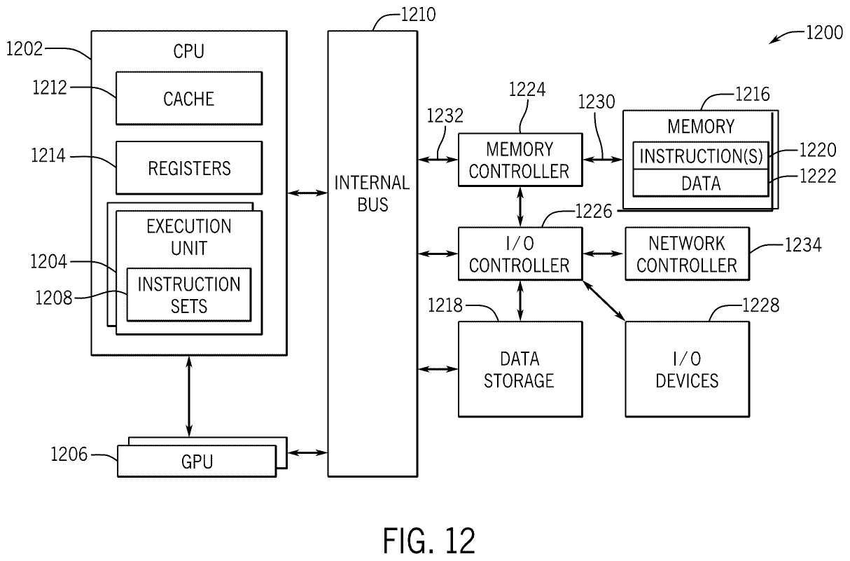

FIG. 12 illustrates a computing features 1200 of an environment for a controller used in a control system, according to at least one embodiment. For example, the computing features 1200 may be used to control one or more pieces of equipment for a containment system and/or to receive information, such as streaming information or periodic information, from one or more connected sensors.

The central processing unit (CPU) 1202 may include one or more execution units 1204 that may include multiple circuits. The CPU 1202 may be a special-purpose processor that is associated with one or more GPUs 1206. The computing features 1200 may be performed by a system-on-a-chip (SoC), or some combination thereof, formed within a CPU 1202. The CPU 1202 may include execution units 1204, as illustrated. The CPU 1202 is able to execute instructions from one or more instruction sets 1208. The CPU 1202 includes support for logic in its execution units 1204. The logic may be used to perform algorithms for processing. Further, the CPU 1202 and the GPUs 1206 include support for performing binary code.

In an example, an execution unit 1204 may include logic to perform integer and floating point (FP) operations. The execution unit 1204 may be within the one or more of the CPU 1202 or the GPUs 1206. However, there may be multiple execution units 1204 that may be coordinated to perform distributed computing features of the testing described herein. Further, one or more of the CPU 1202 or the GPUs 1206 may include a microprocessor code from a read only memory (ROM) for performing macro-instructions. An execution unit 1204 of one or more of the CPU 1202 or the GPUs 1206 may include logic to handle one or more different types of instruction sets 1208.

The one or more different types of instruction sets 1208 may include an instruction set of a special-purpose processor, along with associated circuits to execute instructions therefrom. Further, operations caused by the instructions may be used by the testing related modules described herein. There may be packed data in the one or more of the CPU 1202 or the GPUs 1206 which may be used with the instructions to provide the operations.

The execution unit 1204 may be provided via microcontrollers, embedded processors, or other components of the CPUs, GPUs, or DPUs. However, the execution unit 1204 may be other types of logic circuits than provided in such CPUs, GPUs, or data processing units (DPUs). The computing features 1200 may include a memory 1216 that is external to the one or more of the CPU 1202 or GPUs 1206 but that is coupled to the one or more of the CPU 1202 or GPUs 1206 via a high speed internal bus 1210. This memory 1216 may be a Dynamic Random Access Memory (DRAM), a Static Random Access Memory (SRAM), a flash memory, or any other memory capable of working with the one or more of the CPU 1202 or the GPUs 1206 and with the high speed internal bus 1210. The memory 1216 is distinct from a further data storage 1218 that may be used for long term storage. The memory 1216 may include instruction(s) 1220 and/or data 1222. One or more of the instructions or data may be run or executed by the one or more of the CPU 1202 or the GPUs 1206. The memory may be accessible via a memory controller 1224.

In one example, the CPUs 1202 of the computing features 1200 may include any of a PENTIUM® Processor family from Intel®, including Itanium®, XScale™ and/or StrongARM™; Intel's Core™, Nervana™, or Xeon™ based processors. However, other CPUs, such as AMD®'s Ryzen series, Intel's Core i series, Qualcomm®'s Snapdragon® series, and Samsung®'s Exynos series may also be used. In a further example, the computing features 1200 may include GPUs 1206, such as from NVIDIA®'s GeForce series or AMD®'s Radeon series.

Further, systems of computers may form part or all of the computing features 1200 and may have other types of processors than listed above. These computers may be workstations, set-top boxes, or have similar computing capabilities as these devices and may also be used to perform aspects of the system and method herein. The computing features 1200 may run or execute aspects of an operating system, such as UNIX®, Linux®, or WINDOWS®, and can perform embedded software, as well as support different types of user interfaces, including graphical user interfaces (GUI).

The computing features 1200 may be provided via fixed and mobile devices. These devices include personal computers, workstations, handheld devices, virtual devices, or datacenters. Some examples of mobile devices include laptops, cellular phones, smartphones, Internet Protocol (IP) devices, digital cameras, personal digital assistants (“PDAs”), and other handheld PCs. The computing features 1200 may be performed on virtual devices that are supported by embedded applications. The embedded applications may include a microcontroller, a digital signal processor (DSP), an SOC, network computers, network hubs, switches, routers, gateways, or any other system that may perform one or more instructions described herein.

The computing features 1200 may be supported by one or more of the CPU 1202 or the GPUs 1206 that may include a complex instruction set computer (CISC) microprocessor, a reduced instruction set computing (RISC) microprocessor, a very long instruction word (VLIW) microprocessor, a processor capable of combining instruction sets, or any other processor device. Further examples of a processor device is an application specific integrated circuit (ASIC), a DSP, or a DPU. As illustrated in FIG. 12, one or more of the CPU 1202 or the GPUs 1206 may be associated together and may be associated with other components using a high speed internal bus 1210. The high speed bus 1210 is capable of transmitting data and commands between the one or more of the CPU 1202 or the GPUs 1206 and between other components in the illustrated computing features 1200.

The one or more of the CPU 1202 or the GPUs 1206 may include cache type memory. For example, one or more of the CPU 1202 or the GPUs 1206 may include a Level 1(L1 ) internal cache memory (cache) 1212. In a further example, the one or more of the CPU 1202 or the GPUs 1206 may include one or more internal cache. A multiple cache arrangement may be provided as a hierarchy or as levels of internal cache. As used herein, a cache is a type of memory that may reside internally or externally relative to each of the one or more of the CPU 1202 or the GPUs 1206. There is also possibility for a combination of an internal and external cache based in part on an application of the computing features 1200. Further, the one or more of the CPU 1202 or the GPUs 1206 may include a registry or a register 1214. The registry or register may be a file structure to retain different types of data. For example, there may be different types of the registry or registers. These may include integer registers, floating point (FP) registers, status registers, and an instruction pointer register.

A system logic chip capable of performing as the memory controller 1224 may be provided between to a high speed internal bus 1210 and the memory 1216. The memory controller 1224 and the one or more of the CPU 1202 or the GPUs 1206 may communicate via the high speed internal bus 1210 using a high bandwidth memory path. This allows the one or more of the CPU 1202 or the GPUs 1206 to access the instruction(s) 1220 and the data 1222 for performing the testing described herein. The memory controller 1224 may also be able to direct signals of data between one or more of the CPU 1202 or the GPUs 1206, the memory 1216, and other components in the computing features 1200.

In addition to the above, the memory controller 1224 may also bridge signals of data between a high speed internal bus 1210, a memory 1216, and an input/output (I/O) controller 1226. The memory controller 1224 may include different types of ports, including ports for interfacing with one or more of the CPU 1202 or the GPUs 1206. At least one of the GPUs 1206 may perform as a graphics controller for one of the input/output (I/O) device 1228 which may include a display. The memory controller 1224 may be associated with the memory 1216 through a memory path 1230 that is high bandwidth memory path. Although illustrated as coupled together via a high speed internal bus 1210, the memory controller 1224 may be coupled to one of the GPUs 1206 via an Accelerated Graphics Port (AGP) interconnect 1232. One or more of the CPU 1202 may be coupled to one or more of the GPUs 1206 directly or indirectly via a peripheral component interconnect express (PCIe®) interconnect standard. In addition, a network controller 1234 may also be coupled to one or more of the CPU 1202 or the GPUs 1206 via a different interface that is also a PCIe interconnect standard. Further, some or all of the interconnected devices or chips herein may be provided via SoC. Therefore, some or all of the interconnected devices of FIG. 12 may be interconnected with proprietary interconnects. However, some or all of the interconnected devices of FIG. 12 may be interconnected by a combination of standardized interconnects (such as, PCIe and compute express link or CXL®) and the proprietary interconnects.

The computing features 1200 herein may use the I/O controller 1226 as a proprietary interface to bring together the memory controller 1224, the network controller 1234, and one or more of the other I/O devices 1228. One or more of the controllers herein may include direct connections to some I/O devices 1228 via a local I/O bus that may include a high-speed I/O bus for connecting peripherals to a memory 1216, a chipset, and to one or more of the CPU 1202 or the GPUs 1206. The I/O devices 1228 may include an audio controller, a firmware hub (such as a, a basic input/output system or BIOS), a transceiver, the data storage 1218, a display, and any I/O controllers. The I/O controllers 1226 may include input devices, including a keyboard interface, a mouse interface, a touch interface, a gesture interface, and one or more expansion ports, including a Universal Serial Bus (USB) port. The data storage 1218 may include a flash memory storage, a hard disk drive, or any removable non-transitory storage media having instructions thereon. For example, a CD-ROM device, a flash memory device, or other mass storage device

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Use of terms “a” and “an” and “the” and similar referents in context of describing embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A mounting and alignment system for a manufactured part, comprising:
a mounting portion, comprising:
a concave top surface;
a curved sidewall forming at least a portion of the concave top surface;
a base forming at least a portion of the concave top surface, the base being coupled to the curved sidewall at a transition; and
an adjusting portion, comprising:
a convex bottom surface;
a curved mating surface forming at least a portion of the convex bottom surface; and
a mounting surface, opposite the bottom surface; and
an adjustment system configured to drive movement of the adjusting portion relative to the mounting portion to change an angular orientation of the mounting surface of the adjusting portion, wherein the curved mating surface is configured to mate with the curved sidewall and to move along the curved sidewall responsive to a force from the adjustment system.

2. The mounting and alignment system of claim 1, further comprising:
a plurality of apertures formed in the curved sidewall;
a plurality of holes extending through the curved mating surface; and
a fastening system to secure the adjusting portion to the mounting portion, the fastening system comprising:
a plurality of bolts to be arranged through respective apertures aligned with respective holes; and
a plurality of spherical washers.

3. The mounting and alignment system of claim 2, wherein the plurality of spherical washers engage a fastening surface formed on the adjustment portion.

4. The mounting and alignment system of claim 2, wherein the plurality of spherical washers engage a fastening surface on an opposite side from the curved mating surface.

5. The mounting and alignment system of claim 2, wherein respective aperture diameters of the plurality of apertures are less than respective hole diameters of the plurality of holes.

6. The mounting and alignment system of claim 1, wherein the adjustment system comprises:
a plurality of force members extending through a skirt formed along an outer diameter of the adjustment portion, wherein at least one force member of the plurality of force members is configured to engage the mounting portion to change the angular orientation of the mounting surface from a first orientation to a second orientation.

7. The mounting and alignment system of claim 1, wherein the adjustment system comprises:
a pin extending laterally from the base on a side of the base opposite the transition; and
a two-axis translator coupled to the pin, wherein movement of the pin along a first axis or a second axis of the two-axis translator is configured to change the angular orientation of the mounting surface from a first orientation to a second orientation.

8. The mounting and alignment system of claim 1, wherein the adjustment system comprises:
a first application element; and
a pivot coupled to the base;
wherein a lateral force, applied to the base by the first application element, is configured to change the angular orientation of the mounting surface from a first orientation to a second orientation.

9. An alignment system, comprising:
a bottom support having a first mating surface;
a top support having a second mating surface configured to engage the first mating surface; and
a support driving system configured to move the top support relative to the bottom support, wherein movement of the top support is configured to change an angular orientation of an upper surface of the top support from a first orientation to a second orientation.

10. The alignment system of claim 9, wherein the first mating surface has a first slope, the second mating surface has a second slope, and the support driving system is configured to drive rotational movement of the top support about a longitudinal axis extending through the bottom support and the top support.

11. The alignment system of claim 9, further comprising:
a mounting plate coupled to the top support, wherein the support driving system is configured to adjust a second angular orientation of the mounting plate with respect to the top support.

12. The alignment system of claim 9, wherein the first mating surface is a curved concave surface, the second mating surface is a curved convex surface, and the support driving system is configured to drive longitudinal movement of the top support between a first position and a second position.

13. The alignment system of claim 12, wherein the first mating surface is secured to the second mating surface using one or more fasteners extending through a first hole of the first mating surface and a second hole of the second mating surface.

14. The alignment system of claim 13, wherein a first diameter of the first hole is less than a second diameter of the second hole.

15. The alignment system of claim 9, wherein the support driving system applies at least one of an axial force, a rotational force, or a lateral force to the top support.

16. The alignment system of claim 9, further comprising:
one or more travel indicators positioned at an interface between the first mating surface and the second mating surface.

17. A method to adjust a surface orientation, comprising:
determining a current surface orientation is different from a desired surface orientation;
determining an adjustment to an adjusting portion, relative to a mating portion, to transition from the current surface orientation to the desired surface orientation;
applying the adjustment to the adjusting portion;
determining an adjusted surface orientation is within a threshold amount of the desired surface orientation; and
securing the adjusting portion to the mating portion.

18. The method of claim 17, wherein the adjustment is at least one of a lateral force, an axial force, or a rotational force.

19. The method of claim 17, further comprising:
securing a platform to the adjusting portion; and
securing a working part to the platform.

20. The method of claim 17, wherein the adjustment is configured to cause movement of a curved surface of the adjusting portion along a mating curved surface of the mating portion.
